(19) United States
(12) Patent Application Publication
(10) Pub. No.: US 2026/0350600 A1
(43) Pub. Date: Nov. 5, 2026

(54) METHOD AND SYSTEM FOR IMPLEMENTING IDEMPOTENCY DURING WEB-BASED TRANSACTIONS

(71) Applicant: JPMorgan Chase Bank, N.A., New York, NY (US)

(72) Inventors: Manish SHARMA, Delaware, OH (US); Harish Pramod AGRAWAL, Lewis Center, OH (US)

(73) Assignee: JPMorgan Chase Bank, N.A., New York, NY (US)

(21) Appl. No.: 19/195,062

(22) Filed: Apr. 30, 2025

(51) Int. Cl. G06Q 20/38; G06Q 20/40

(52) U.S. Cl. CPC G06Q 20/3829; G06Q 20/405

(57) ABSTRACT

A method and a system for implementing idempotency during web-based transactions are provided. The method includes: intercepting a first request for selecting a payment option; retrieving an idempotency key based on a session identifier or a device identifier; transmitting the first request to a payment service provider, based on the idempotency key; intercepting a second request to add a payment, which includes the idempotency key and a first payment amount; determining whether the idempotency key is in a valid state; when the idempotency key is in the valid state, transmitting the second request to the payment service provider; receiving a third request to validate the idempotency key from the payment service provider; determining whether the idempotency key is in the valid state; and when the idempotency key is in the valid state, transmitting an authorization for adding the payment to the payment service provider.

### BACKGROUND

### 1. Field of the Disclosure

This disclosure generally relates to methods and systems for implementing idempotency during web-based transactions, and more particularly to methods and systems for associating payment service requests with an idempotency key and analyzing the idempotency key at defined intervals in order to prevent duplicate transactions.

### 2. Background Information

Current banking architectures are founded on autonomous applications comprised of event driven or Webservices based microservices. This type of architecture is required to support a web-scale model where a high availability of services and a sustained speed of delivery are vital. Several challenges may arise when using non-idempotent methods like the Post method in Hypertext Transfer Protocol (HTTP) Application Programming Interfaces (APIs), especially in scenarios where network issues or timeouts occur. For example, it may be unclear whether a resource is actually created or updated. Particularly, when a client experiences a timeout, it may be unclear whether the server processed the request. The resource might have been created or updated, or the request might not have reached the server at all.

Additionally, it may be unclear whether the timeout occurred during the sending of the request, or when receiving the response. Timeouts can occur at various stages including while sending the request, during processing on the server, or while receiving the response. Without additional information, it may be difficult to determine the exact stage where the timeout happened. This may create the challenge of trying to determine whether the client can safely retry the request, or is it required to figure out what happened in the first place. Retrying a Post request without knowing the outcome of the previous attempt can lead to duplication or unintended updates. To handle these issues, clients may use various techniques (e.g., conditional requests and status checks) to help ensure that requests are only processed once. However, even after the implementation of these current methods there is a possibility of creating duplicate transactions/payments due to double submission of the transactions.

Current techniques for processing transactions suffer from issues including data inconsistency, unintended side effects, network reliability challenges, problems with error recovery, lack of consistency across systems, and negative user experiences. For example, in current computer-based techniques, repeated operations can lead to inconsistent data states. For instance, if a payment request is accidentally processed multiple times, it could result in duplicate charges. Additionally, current techniques can cause unintended side effects, such as: 1) duplicate transactions, in which multiple processing of the same transaction can lead to duplicates, which can be costly and difficult to reconcile; 2) incorrect data updates, in which repeated updates without idempotency can overwrite data incorrectly or apply changes multiple times, leading to errors; and 3) resource overutilization, in which non-idempotent operations can consume more resources than necessary, as they may trigger repeated actions like sending multiple emails or notifications.

Moreover, in distributed systems, network issues such as timeouts or dropped connections are common. Clients may retry requests to ensure they are processed, however these duplicate requests may not be recognized and/or handled appropriately. There may also be issues with error recovery as the complexity of client-side logic is increased, causing a greater likelihood of error and/or increased processing time. Additionally, systems that interact with multiple services or databases, may fall out of sync, especially when components experience failures or delays. Also, in current systems, end-users are prone to experience confusion and frustration caused by duplicate actions, such as being charged multiple times for a single purchase or receiving multiple confirmations for the same action.

Accordingly, there is a need for a system that associates payment service requests with an idempotency key and analyzes the idempotency key at defined intervals in order to prevent duplicate transactions. Particularly, the system should prevent the processing of duplicate transactions while reducing the complexity in client-side logic and improving the robustness of the system.

### SUMMARY

The present disclosure, through one or more of its various aspects, embodiments, and/or specific features or sub-components, provides, inter alia, various systems, servers, devices, methods, media, programs, and platforms for associating payment service requests with an idempotency key and analyzing the idempotency key at defined intervals in order to prevent duplicate transactions.

According to an aspect of the present disclosure, a method for implementing idempotency during web-based transactions is provided. The method may be implemented by at least one processor. The method may include: intercepting, by the at least one processor, a first request for selecting a payment option; retrieving, by the at least one processor, an idempotency key based on at least one from among a session identifier and a device identifier associated with the first request; transmitting, by the at least one processor, the first request to a payment service provider, based on a result of the retrieving of the idempotency key; intercepting, by the at least one processor, a second request to add a payment, wherein the second request includes the idempotency key and a first payment amount; determining, by the at least one processor, whether the idempotency key is in a valid state; when the idempotency key is determined to be in the valid state, transmitting, by the at least one processor, the second request to the payment service provider; receiving, by the at least one processor, a third request to validate the idempotency key from the payment service provider; determining, by the at least one processor, whether the idempotency key is in the valid state; and when the idempotency key is determined to be in the valid state, transmitting, by the at least one processor, an authorization for adding the payment to the payment service provider.

The method may further include updating, by the at least one processor, a status of the idempotency key based on a result of the transmitting of the authorization.

The method may further include intercepting, by the at least one processor, a fourth request to proceed with a payment option, wherein the fourth request includes the idempotency key; determining, by the at least one processor, whether the idempotency key is in the valid state; and when the idempotency key is determined to be in the valid state, transmitting, by the at least one processor, the fourth request to the payment service provider.

The method may further include when the authorization for adding the payment is transmitted to the payment service provider, updating, by the at least one processor, a status of the idempotency key to an expired state; intercepting, by the at least one processor, a fifth request to add a payment, wherein the fifth request includes the idempotency key and the first payment amount; determining, by the at least one processor, that the idempotency key is in the expired state; and stopping, by the at least one processor, the fifth request from being transmitted to the payment service provider.

The method may further include when the authorization for adding the payment is transmitted to the payment service provider, updating, by the at least one processor, a status of the idempotency key to an expired state; intercepting, by the at least one processor, a sixth request to add a payment, wherein the sixth request includes the idempotency key and a second payment amount that is different from the first payment amount; determining, by the at least one processor, that the idempotency key is in the expired state; generating, by the at least one processor, an error code; and stopping, by the at least one processor, the sixth request from being transmitted to the payment service provider.

The method may further include generating, by the at least one processor, the idempotency key prior to the retrieving, based on at least one from among the session identifier and the device identifier.

The method may further include determining, by the at least one processor, a status state of the idempotency key; and storing, by the at least one processor, the status state in a database, wherein the determining of whether the idempotency key is in the valid state includes retrieving the status state from the database.

The determining of whether the idempotency key is in the valid state includes analyzing a lifecycle and a status state of the idempotency key to ensure that an order to the payment service provider for adding a payment has not been processed more than once.

According to another aspect of the present disclosure, a computing apparatus for implementing idempotency during web-based transactions is provided. The computing apparatus may include a processor; a memory; and a communication interface coupled to each of the processor and the memory. The processor may be configured to: intercept a first request for selecting a payment option; retrieve an idempotency key based on at least one from among a session identifier and a device identifier associated with the first request; transmit the first request to a payment service provider, based on a result of the retrieving of the idempotency key; intercept a second request to add a payment, wherein the second request includes the idempotency key and a first payment amount; determine whether the idempotency key is in a valid state; when the idempotency key is determined to be in the valid state, transmit the second request to the payment service provider; receive a third request to validate the idempotency key from the payment service provider; determine whether the idempotency key is in the valid state; and when the idempotency key is determined to be in the valid state, transmit an authorization for adding the payment to the payment service provider.

The processor may be further configured to update a status of the idempotency key based on a result of the transmitting of the authorization.

The processor may be further configured to: intercept a fourth request to proceed with a payment option, wherein the fourth request includes the idempotency key; determine whether the idempotency key is in the valid state; and when the idempotency key is determined to be in the valid state, transmit the fourth request to the payment service provider.

The processor may be further configured to: when the authorization for adding the payment is transmitted to the payment service provider, update a status of the idempotency key to an expired state; intercept a fifth request to add a payment, wherein the fifth request includes the idempotency key and the first payment amount; determine that the idempotency key is in the expired state; and stop the fifth request from being transmitted to the payment service provider.

The processor may be further configured to: when the authorization for adding the payment is transmitted to the payment service provider, update a status of the idempotency key to an expired state; intercept a sixth request to add a payment, wherein the sixth request includes the idempotency key and a second payment amount that is different from the first payment amount; determine that the idempotency key is in the expired state; generate an error code; and stop the sixth request from being transmitted to the payment service provider.

The processor may be further configured to: generate, based on at least one from among the session identifier and the device identifier, the idempotency key prior to the retrieving.

The processor may be further configured to: determine a status state of the idempotency key; and store the status state in a database, wherein the determining of whether the idempotency key is in the valid state includes retrieving the status state from the database.

The determining of whether the idempotency key is in the valid state includes analyzing a lifecycle and a status state of the idempotency key to ensure that an order to the payment service provider for adding a payment has not been processed more than once.

According to yet another aspect of the present disclosure, a non-transitory computer readable storage medium storing instructions for implementing idempotency during web-based transactions is provided. The storage medium includes executable code which, when executed by a processor, may cause the processor to: intercept a first request for selecting a payment option; retrieve an idempotency key based on at least one from among a session identifier and a device identifier associated with the first request; transmit the first request to a payment service provider, based on a result of the retrieving of the idempotency key; intercept a second request to add a payment, wherein the second request includes the idempotency key and a first payment amount; determine whether the idempotency key is in a valid state; when the idempotency key is determined to be in the valid state, transmit the second request to the payment service provider; receive a third request to validate the idempotency key from the payment service provider; determine whether the idempotency key is in the valid state; and when the idempotency key is determined to be in the valid state, transmit an authorization for adding the payment to the payment service provider.

The executable code may further cause the processor to update a status of the idempotency key based on a result of the transmitting of the authorization.

The executable code may further cause the processor to: intercept a fourth request to proceed with a payment option, wherein the fourth request includes the idempotency key; determine whether the idempotency key is in the valid state; and when the idempotency key is determined to be in the valid state, transmit the fourth request to the payment service provider.

The executable code may further cause the processor to: when the authorization for adding the payment is transmitted to the payment service provider, update a status of the idempotency key to an expired state; intercept a fifth request to add a payment, wherein the fifth request includes the idempotency key and the first payment amount; determine that the idempotency key is in the expired state; and stop the fifth request from being transmitted to the payment service provider.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for associating payment service requests with an idempotency key and analyzing the idempotency key at defined intervals in order to prevent duplicate transactions, according to an embodiment.

FIG. 2 illustrates a diagram of a network environment for associating payment service requests with an idempotency key and analyzing the idempotency key at defined intervals in order to prevent duplicate transactions, according to an embodiment.

FIG. 3 illustrates a system diagram of a system for associating payment service requests with an idempotency key and analyzing the idempotency key at defined intervals in order to prevent duplicate transactions, according to an embodiment.

FIG. 4 illustrates a process diagram of a process for associating payment service requests with an idempotency key and analyzing the idempotency key at defined intervals in order to prevent duplicate transactions, according to an embodiment.

FIG. 5 illustrates a system diagram for associating payment service requests with an idempotency key and analyzing the idempotency key at defined intervals in order to prevent duplicate transactions, according to an embodiment.

FIG. 6 illustrates a flow diagram of a process for associating payment service requests with an idempotency key and analyzing the idempotency key at defined intervals in order to prevent duplicate transactions, according to an embodiment.

FIG. 7 illustrates a flow diagram of a process for associating payment service requests with an idempotency key and analyzing the idempotency key at defined intervals in order to prevent duplicate transactions, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein implements an idempotency key during web-based transactions to prevent duplicate transactions and ensure reliability and consistency in transactional operations. Particularly, when a user requests to select a payment option for performing an online or web-based transaction, the system may first intercept the request. The system may then generate or retrieve a previously generated idempotency key associated with the request. Once the idempotency key is retrieved, the request may be transmitted to the appropriate payment service provider with the idempotency key. After this request is transmitted to the payment service provider, the user may then receive a prompt through the website to input their payment information. Once the user puts in their payment information and submits a second request to add the payment, the system may then intercept this request, including the idempotency key. The system may determine whether the idempotency key is valid. If the key is valid, the system may then transmit the request for adding payment to the payment service provider. Next, the system may receive a request from the payment service provider to validate the idempotency key. The system may then determine whether the idempotency key is valid, and if the key is valid, the system may transmit authorization for adding the payment to the payment service provider. Once the authorization has been completed, the idempotency key may be updated to an expired state, thus preventing duplicate transactions.

By implementing and verifying an idempotency key through various stages of the payment authorization process, the system can ensure reliability and consistency in the face of network issues, retries, and failures. The use of this system prevents inconsistent data states during repeated operations. For example, if a payment request is accidentally processed multiple times, it could result in duplicate charges. This idempotency-based system ensures that repeated requests have the same effect as a single request, maintaining a consistent and accurate state. Additionally, the idempotency-based system prevents a plurality of unintended side effects that may occur in current computer and web-based systems, thereby providing a technological improvement to conventional technologies. For example, the system prevents duplicate transactions, which is caused by multiple processing of the same transaction that leads to duplicates, and can be costly and difficult to reconcile. The system also reduces errors by preventing incorrect data updates, in which repeated updates without idempotency can overwrite data incorrectly or apply changes multiple times, leading to errors. Moreover, the system helps reduce and prevent resource overutilization. Particularly, non-idempotent operations can consume more resources than necessary, as they may trigger repeated actions, including sending multiple emails or notifications.

Additionally, the idempotency-based system improves network reliability. For example, in distributed systems, network issues such as timeouts or dropped connections are common. Clients may retry requests to ensure they are processed. Idempotency allows these retries to be safe, as the server can recognize and handle duplicate requests appropriately. The system also improves error recovery. Idempotency simplifies error recovery by allowing clients to retry operations without needing to determine the exact state of the previous request. This reduces complexity in client-side logic and improves the robustness of the system. Moreover, the system also improves consistency across systems. In systems that interact with multiple services or databases, idempotency helps ensure that all parts of the system remain in sync, even if some components experience failures or delays. The system also improves the user experience. For end-users, idempotency can prevent confusion and frustration caused by duplicate actions, such as being charged multiple times for a single purchase or receiving multiple confirmations for the same action. Thus, idempotency is a key design principle that helps maintain the integrity and reliability of systems, especially in environments where operations may be repeated due to retries or failures.

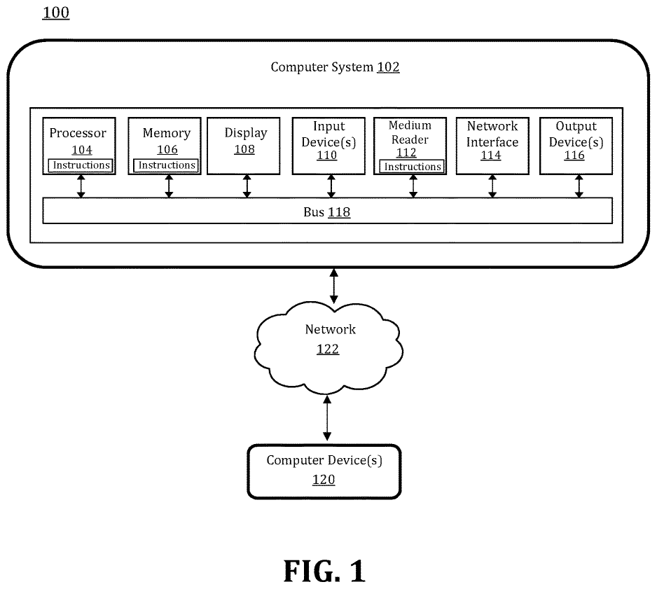

FIG. 1 is a system 100 for associating payment service requests with an idempotency key and analyzing the idempotency key at defined intervals in order to prevent duplicate transactions, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the idempotency key module implemented by the system 100 may allow for associating payment service requests with an idempotency key and analyzing the idempotency key at defined intervals in order to prevent duplicate transactions. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

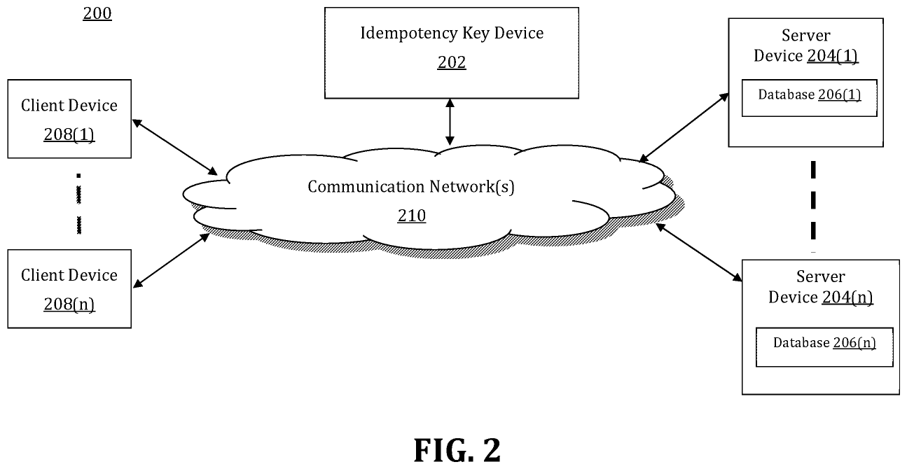

Referring to FIG. 2, a schematic of a network environment 200 for associating payment service requests with an idempotency key and analyzing the idempotency key at defined intervals in order to prevent duplicate transactions is illustrated.

In some embodiments, the above-described problems associated with conventional tools may be overcome by implementing an idempotency key device 202 as illustrated in FIG. 2 that may be configured for associating payment service requests with an idempotency key and analyzing the idempotency key at defined intervals in order to prevent duplicate transactions, but the disclosure is not limited thereto.

The idempotency key device 202 may include one or more computer systems 102, as described with respect to FIG. 1, which in aggregate provide the necessary functions.

The idempotency key device 202 may store one or more applications that can include executable instructions that, when executed by the idempotency key device 202, cause the idempotency key device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the idempotency key device 202 itself, may be located in virtual server(s) running in a cloud-based computing environment rather than being tied to one or more specific physical network computing devices. Also, the application(s) may be running in one or more virtual machines (VMs) executing on the idempotency key device 202. Additionally, in one or more embodiments of this technology, virtual machine(s) running on the idempotency key device 202 may be managed or supervised by a hypervisor.

In the network environment 200 of FIG. 2, the idempotency key device 202 may be coupled to a plurality of server devices 204(1)-204(n) that hosts a plurality of databases 206(1)-206(n), and also to a plurality of client devices 208(1)-208(n) via communication network(s) 210. A communication interface of the idempotency key device 202, such as the network interface 114 of the computer system 102 of FIG. 1, operatively couples and communicates between the idempotency key review device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the idempotency key device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The idempotency key device 202 may be a standalone device or integrated with one or more other devices or apparatuses, such as one or more of the server devices 204(1)-204(n), for example. In one example, the idempotency key device 202 may be hosted by one of the server devices 204(1)-204(n), and other arrangements are also possible. Moreover, one or more of the devices of the idempotency key device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the idempotency key device 202 via the communication network(s) 210 according to the HTTP-based and/or JSON protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the idempotency key device 202 that may associate payment service requests with an idempotency key and analyze the idempotency key at defined intervals in order to prevent duplicate transactions, but the disclosure is not limited thereto.

The client devices 208(1)-208(n) may run interface applications, such as standard web browsers or standalone client applications, which may provide an interface to communicate with the idempotency key device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the idempotency key device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the idempotency key device 202, the server devices 204(1)-204(n), or the client devices 208(1)-208(n), for example, may be configured to operate as virtual instances on the same physical machine. For example, one or more of the idempotency key devices 202, the server devices 204(1)-204(n), or the client devices 208(1)-208(n) may operate on the same physical device rather than as separate devices communicating through communication network(s) 210. Additionally, there may be more or fewer idempotency key devices 202, server devices 204(1)-204(n), or client devices 208(1)-208(n) than illustrated in FIG. 2. In some embodiments, the idempotency key device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

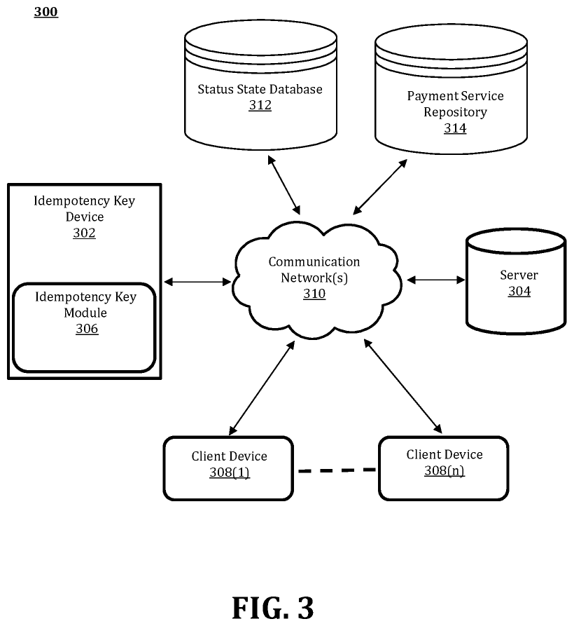

FIG. 3 illustrates a system diagram for associating payment service requests with an idempotency key and analyzing the idempotency key at defined intervals in order to prevent duplicate transactions, in accordance with an embodiment.

As illustrated in FIG. 3, the system 300 may include an idempotency key device 302 within which an idempotency key module 306 is embedded, a server 304, a status state database 312, a payment service repository 314, a plurality of client devices 308(1) ... 308(n), and a communication network 310.

In some embodiments, the idempotency key device 302 including the idempotency key module 306 may be connected to the server 304, the status state database 312, and the payment service repository 314 via the communication network 310. The idempotency key device 302 may also be connected to the plurality of client devices 308(1) ... 308(n) via the communication network 310, but the disclosure is not limited thereto. The status state database 312 and the payment service repository 314 may include one or more repositories or databases.

In an embodiment, the idempotency key device 302 is described and shown in FIG. 3 as including the idempotency key module 306, although it may include other rules, policies, modules, databases, or applications, for example. In some embodiments, the status state database 312 and the payment service repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the status state database 312 and the payment service repository 314 may be a mainframe database, a log database that may produce programming for searching, monitoring, and analyzing machine-generated data via a web interface, but the disclosure is not limited thereto. In addition, the status state database 312 and the payment service repository 314 may store a plurality of data sets and predictive models used for preventing duplicate transactions.

In some embodiments, the idempotency key module 306 may be configured to receive a real-time feed of data from the plurality of client devices 308(1) ... 308(n) and secondary sources via the communication network 310.

The idempotency key module 306 may be configured to: intercept a first request for selecting a payment option; retrieve an idempotency key based on at least one from among a session identifier and a device identifier associated with the first request; transmit the first request to a payment service provider, based on a result of the retrieving of the idempotency key; intercept a second request to add a payment, wherein the second request includes the idempotency key and a first payment amount; determine whether the idempotency key is in a valid state; when the idempotency key is determined to be in the valid state, transmit the second request to the payment service provider; receive a third request to validate the idempotency key from the payment service provider; determine whether the idempotency key is in the valid state; and when the idempotency key is determined to be in the valid state, transmit an authorization for adding the payment to the payment service provider.

The plurality of client devices 308(1) ... 308(n) are illustrated as being in communication with the idempotency key device 302. In this regard, the plurality of client devices 308(1) ... 308(n) may be “clients” (e.g., customers) of the idempotency key device 302 and are described herein as such. Nevertheless, it is to be known and understood that the plurality of client devices 308(1) ... 308(n) need not necessarily be “clients” of the idempotency key device 302, or any entity described in association therewith herein. Any additional or alternative relationship may exist between either or both plurality of client devices 308(1) ... 308(n) and the idempotency key device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) ... 308(n) may communicate with the idempotency key device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The idempotency key device 302 may be the same or similar to the idempotency key device 202 as described with respect to FIG. 2, including any features or combination of features described with respect thereto.

Upon being started, the idempotency key device 302 executes a process for associating payment service requests with an idempotency key and analyzing the idempotency key at defined intervals in order to prevent duplicate transactions.

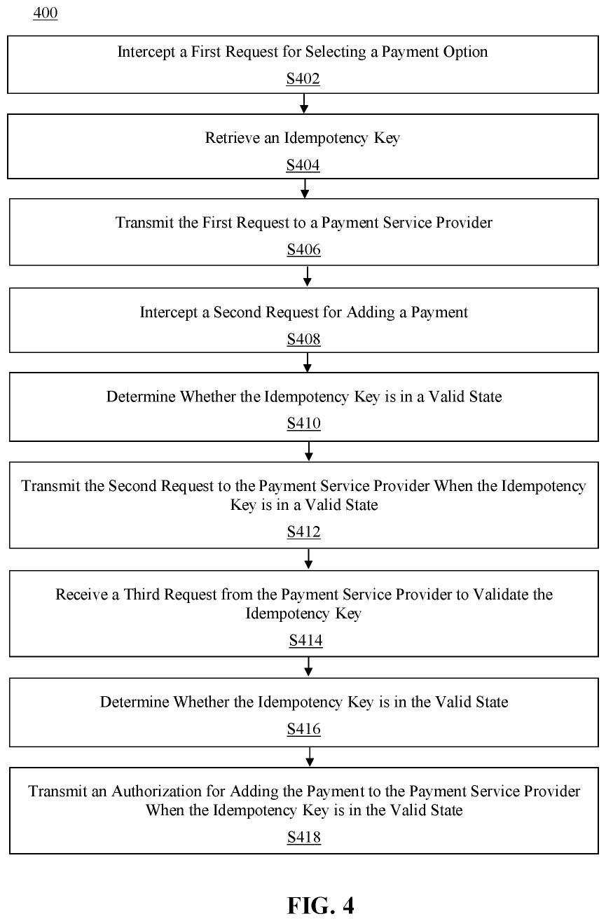

FIG. 4 illustrates a process 400 for associating payment service requests with an idempotency key and analyzing the idempotency key at defined intervals in order to prevent duplicate transactions, according to an embodiment.

In process 400 of FIG. 4, at step S402, the idempotency key device 302 may intercept a first request for selecting a payment option. For example, in an embodiment, a user may be on a website or online portal that provides a list of goods or services for purchase. When the user decides that they would like to purchase an item or service, the user may click a button or link to select a payment option, which then generates a request to be sent to a payment service provider. Once the user clicks on this button or link, the idempotency key device 302 may intercept the generated request for selecting a payment option before it is transmitted to the payment service provider. The payment option may be for selecting at least one from among a bank account, debit card, credit card, and/or payment service.

At step S404, the idempotency key device 302 may retrieve an idempotency key that is associated with the first request for selecting a payment option. In an embodiment, the idempotency key may be based on at least one from among a session identifier and a device identifier associated with the first request. In some embodiments, the idempotency key device 302 may first generate the idempotency key for the first request, based on the session identifier and the device identifier associated with the first request. For example, in an embodiment, after the user initiates the add payment journey, a network interceptor associated with the idempotency key device 302 may intercept the service call and make an offline call to an idempotency service to generate or retrieve the already generated idempotency key.

At step S406, the idempotency key device 302 may then transmit the first request to the payment service provider with the idempotency key. For example, if the user has decided to proceed with a transaction and wants to select an option for choosing a type of payment, the system will then transmit this request to the appropriate third-party payment service provider with the retrieved idempotency key.

In some embodiments, the idempotency key device 302 may also intercept a request to proceed with a payment option. This request may include the idempotency key. The idempotency key device 302 may determine whether the idempotency key is valid, and if it is valid, transmit the request to the payment service provider. For example, in an embodiment, if the user requests to select a third-party payment service as a payment provider, the system then generates a request to the appropriate third-party payment service provider with the retrieved idempotency key. The idempotency key device 302 may then intercept that request and determine whether the idempotency key is in a valid state. If the idempotency key is in the valid state, the request is then transmitted to the appropriate third-party payment service provider. If the idempotency key is not in a valid state, the request will not be transmitted to the payment service provider.

At step S408, the idempotency key device 302 may intercept a second request associated with adding a payment. For example, the user may choose to input their credit card information to add as a payment type for purchasing the selected good or service. Once the user inputs the appropriate information, the user may click a button or link to add the payment, which then generates the second request to be sent to the payment service provider. Once the user clicks on this button or link, the idempotency key device 302 may intercept the generated second request before it is transmitted to the payment service provider. The second request may include the idempotency key.

At step S410, the idempotency key device 302 may analyze the second request and determine whether the idempotency key associated with the second request is valid. For example, the idempotency key device 302 may determine the corresponding status state of the idempotency key. The status state of the idempotency key may be in at least one selected from among an expired state, an active/valid state, and an error state. If the idempotency key is in an active/valid state, the second request is determined to be valid. In an embodiment, the status state may be stored in a database (e.g., the status state database 312). Each subsequent time the state/status of the idempotency key needs to be determined, it may be retrieved from the database. In some embodiments, the determining of whether the idempotency key is in the valid state includes analyzing a lifecycle and a status state of the idempotency key to ensure that an order to the payment service provider for adding a payment has not been processed more than once.

Next, at step S412, the idempotency key device 302 may transmit the second request to the payment service provider, when the idempotency key is in the active/valid state and the second request is determined to be valid.

At step S414, the idempotency key device 302 may receive a third request to validate the idempotency key from the payment service provider. For example, in an embodiment, once the service provider receives the second request with the idempotency key, the service provider needs to verify that the idempotency key is valid before it can proceed with authorization of the request/transaction. The service provider may then transmit a message that includes the idempotency key to the idempotency key device 302 to determine the state of the idempotency key. Next, at step S416, the idempotency key device 302 may determine whether the idempotency key is in a valid state. The idempotency key may be in at least one selected from among an expired state, an active/valid state, and an error state.

Then, at step S418, the idempotency key device 302 may transmit authorization to the payment service provider, if the idempotency key is determined to be in an active/valid state. For example, the idempotency key device 302 indication that the idempotency key is valid may enable the payment service provider to complete the addition of the selected payment and authorize the completion of the request/transaction. In an embodiment, if the idempotency key is determined to be in at least one from among an expired state, an error state, or any non-active/invalid state, the request/transaction will not be authorized, and the payment method will not be added and/or charged.

In some embodiment, after the transaction has been authorized, the idempotency key will be updated from an active/valid state to an expired state. For example, if at step S416, the idempotency key is determined to be in the valid state, and then, at step S418 the authorization for the request is transmitted, the idempotency key device 302 may then change the state of the idempotency key to an expired state. In an embodiment, when a request is made after the idempotency key is changed to the expired state, any subsequent request that includes that idempotency key will be stopped by the idempotency key device 302, and the request will be prevented from being transmitted to the payment service provider. This helps prevent duplicate transactions from occurring.

In some embodiments, in addition to determining the state of the idempotency key, the idempotency key device 302 may also analyze the payment amount associated with the request/transaction. For example, if a transaction for certain amount A is successfully processed and the idempotency key is changed to an expired state, then, if an additional request for the amount A is received or intercepted and the idempotency key is determined to be expired, the idempotency key device 302 may recognize this as a duplicate request/transaction and prevent it from being transmitted to the payment service provider. Alternatively, if the additional request is for the amount B, which is different than the amount A, and the idempotency key is determined to be expired, the idempotency key device 302 may recognize this error, generate the appropriate error code, and prevent the request/transaction from being transmitted.

The idempotency key device 302 may contain a system architecture or workflow that involves the life cycle of idempotency keys, particularly in the context of handling payments and ensuring that requests are processed correctly without duplication. For example, the idempotency key device 302 may contain a user interface that acts as a network interceptor. This component may include a pay options network interceptor that may be the first or main component in the system, and may intercept the service call when a customer initiates the add payment journey. Additionally, the network interceptor may intercept the service call and make an offline call to an idempotency service to generate or retrieve the idempotency key already generated by an identifier service. The user interface may also include an add payment component that is responsible for initiating payment requests, and may manage both success and failure responses.

The user interface may also include an error handling component, such that if an error occurs due to an idempotency key being used or expired, the system is able to manage the situation gracefully. The user interface may improve idempotency key management. For example, the interceptor may retrieve the idempotency key using a session ID or device ID, which is crucial for ensuring that repeated requests do not result in duplicate processing. The user interface may also check if the idempotency key is processed or expired. If it is expired, a new key needs to be created. Additionally, the idempotency key device 302 may contain a mobile application component that performs all the features of the user interface but on or through a mobile application.

The idempotency key device 302 may utilize a session ID/device ID component, which ensures that only one active idempotency key is generated per session ID or device ID. Until the transaction is submitted or the idempotency key is expired, the system will not generate a new idempotency key. The idempotency key device 302 may include a product service component that interacts with downstream systems to process the actual business logic related to the product or payment. And the idempotency key device 302 may also include or interact with downstream systems that may be external or internal services that ultimately process the requests initiated by the user interface or mobile application. They may rely on the idempotency key to ensure that operations are not duplicated.

The idempotency key device 302 may also utilize an identifier service, which may validate the idempotency key or update its status if it has been processed. The identifier service may also ensure that an active idempotency key is available for use. The identifier service may also manage the state of idempotency keys, and may store this information in a database. The database may store the status state and details of idempotency keys, including their association with session IDs and transaction IDs. The Identifier Service may be an autonomous application. Additionally, the identifier service may utilize business logic and may have a hexagonal architectural structure. The hexagonal architecture may be based on three principles and techniques: 1) explicitly separate application, domain, and infrastructure; 2) dependencies go from application and infrastructure to the domain; and 3) isolate the boundaries by using ports and adapters. Included in the identifier service's logic may be an encoded business process. Surrounding the business logic may be the following adapters: 1) an inbound adapter that consumes domain events or service calls that other microservices fetch and communicates out during a state change in the idempotency key; 2) a database adapter that is an inbound/outbound adapter that accesses the database to save/update or retrieve the generated idempotency key for the session ID or device ID.

In this architecture, idempotency keys play a critical role in ensuring that requests are processed exactly once, even in the face of network issues or retries. By managing the lifecycle and state of these keys, the system can provide reliable and consistent behavior across different components and services.

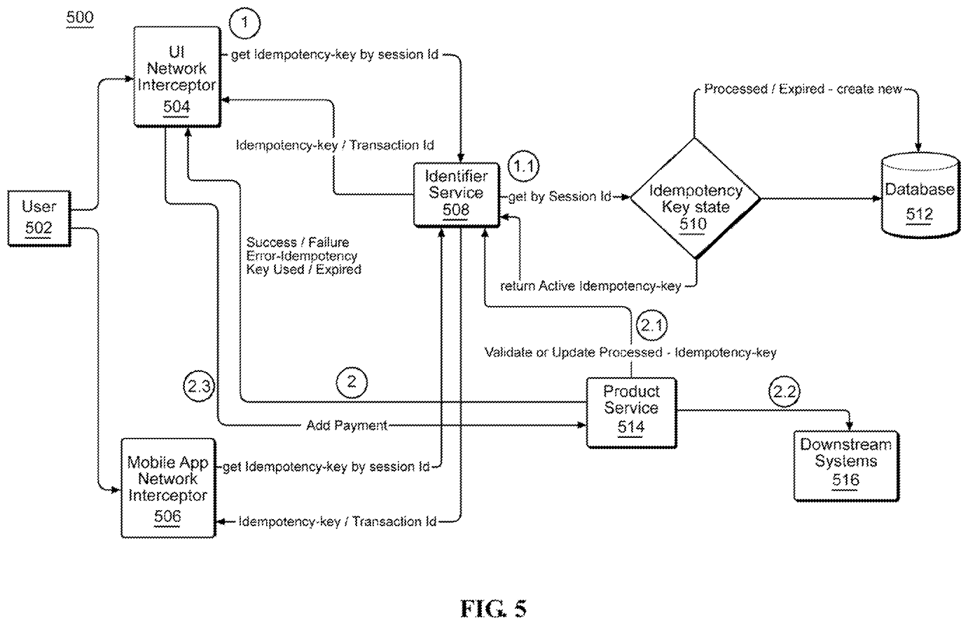

FIG. 5 illustrates a system diagram 500 for associating payment service requests with an idempotency key and analyzing the idempotency key at defined intervals in order to prevent duplicate transactions, according to an embodiment.

FIG. 5 shows a system 500 in which a user 502 initiates a request to add a payment for a transaction. The request may be intercepted by either a user interface (UI) network interceptor 504 or a mobile application network interceptor 506, depending on how the request/transaction is initiated. For example, if the request/transaction is initiated within a mobile application it may be intercepted by the mobile application network interceptor 506. All other methods of initiating the request/transaction may be intercepted by the user interface network interceptor 504. The user interface network interceptor 504 or the mobile application network interceptor 506 uses a session identifier (ID) associated with the request/transaction to retrieve the idempotency key for the request from an identifier service 508. The identifier service 508 retrieves the idempotency key by transmitting the session ID to an idempotency key state module 510. If an idempotency key associated with the session ID exists, the idempotency key state module 510 retrieves the idempotency key from a database 512 and determines whether the idempotency key is active/valid. If there is no idempotency key associated with the session ID, the idempotency key state module 510 creates a new active/valid idempotency key that is then stored in the database 512.

Once an idempotency is determined to be valid or is generated, the idempotency key is transmitted to the identifier service 508. The identifier service 508 then transmits the active/valid idempotency key along with the corresponding transaction ID to one of the user interface network interceptor 504 or the mobile application network interceptor 506. Next, the request to add payment is transmitted from one of the user interface network interceptor 504 or the mobile application network interceptor 506 to a product service provider 514. The product service provider 514 then transmits the idempotency key to the identifier service 508, which determines whether the idempotency key is in a valid state. Based on the results of this determination, the product service provider 514 transmits a success/failure message to one of the user interface network interceptor 504 or the mobile application network interceptor 506, along with the status state of the idempotency key. If the idempotency key is valid, the request is authorized and transmitted to downstream systems 516 for subsequent processing.

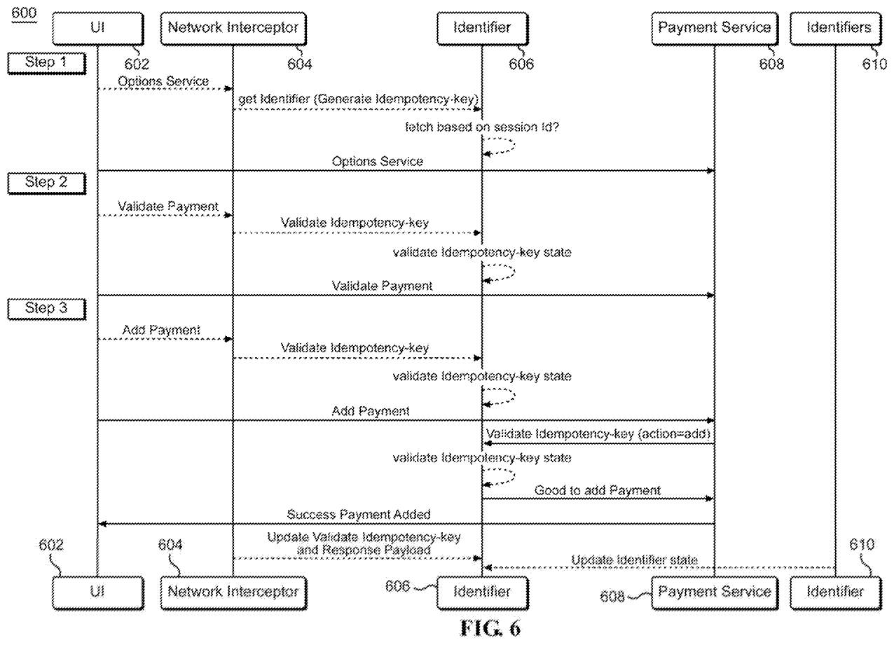

FIG. 6 illustrates a flow diagram 600 of a process for associating payment service requests with an idempotency key and analyzing the idempotency key at defined intervals in order to prevent duplicate transactions, according to an embodiment.

FIG. 6 shows that at step 1, a payment service option request is submitted at a user interface 602. This request is then intercepted by the network interceptor 604. The network interceptor 604 then retrieves an idempotency key that is generated by the identifier 606. The idempotency key may be based on the session ID associated with the request. The payment service option request is then transmitted to the payment service 608. At step 2, a request to validate a payment option is transmitted by the user interface 602 and is intercepted by the network interceptor 604. The network interceptor 604 uses the identifier 606 for validating the idempotency key. Particularly, the identifier 606 determines whether the idempotency key is in a valid state. If the idempotency key is in a valid state, the request to validate the payment option is then transmitted to the payment service 608.

At step 3, a request to add a payment is transmitted by the user interface 602 and is intercepted by the network interceptor 604. The network interceptor 604 uses the identifier 606 for validating the idempotency key. Particularly, the identifier 606 determines whether the idempotency key is in a valid state. If the idempotency key is in a valid state, the request to add the payment is then transmitted to the payment service 608. The payment service 608 then submits a request to validate the idempotency key to the identifier 606. If the idempotency key is in an active/valid state, the identifier 606 notifies the payment service 608 that it is good to add the payment. Next, the payment service 608 transmits a message to the user interface 602 that the payment has been successfully added. The network interceptor 604 then sends a message to the identifier 606 to update the idempotency key state and response payload. Then a series of identifiers 610 updates the identifier state of the idempotency key at the identifier 606.

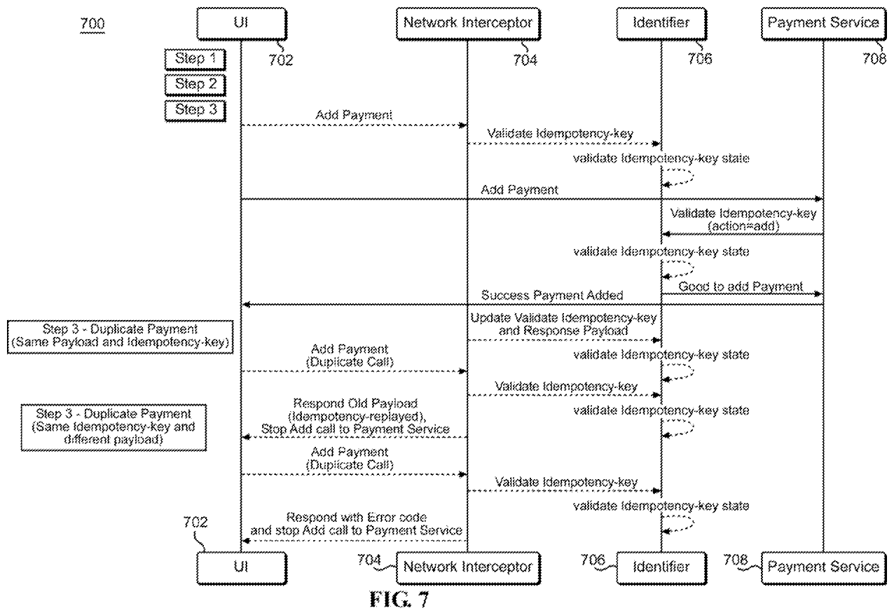

FIG. 7 illustrates a flow diagram 700 of a process for associating payment service requests with an idempotency key and analyzing the idempotency key at defined intervals in order to prevent duplicate transactions, according to an embodiment. Particularly, FIG. 7 shows a series of steps and actions performed by the system for three different scenarios following the completion of steps 1 and 2, as illustrated and described in FIG. 6.

In the first scenario shown in FIG. 7, the idempotency key is in a valid state and step 3 proceeds similar to the step 3 illustrated and described in FIG. 6. Particularly, for this first scenario, a request to add a payment is transmitted by the user interface 702 and is intercepted by the network interceptor 704. The network interceptor 704 uses the identifier 706 to validate the idempotency key as being in an active/valid state. Because the idempotency key is in a valid state, the request to add the payment is then transmitted to the payment service 708. The payment service 708 then submits a request to validate the idempotency key to the identifier 706. Because the idempotency key is in an active/valid state, the identifier 706 notifies the payment service 708 that it is good to add the payment. Next, the payment service 708 transmits a message to the user interface 702 that the payment has been successfully added. The network interceptor 704 then sends a message to the identifier 706 to update the idempotency key state and record the response payload (i.e., payment amount).

FIG. 7 shows a second step 3 scenario in which a duplicate payment request, having the same payload (i.e., payment amount) and the same idempotency key, is made. In this scenario, a duplicate call to add a payment is transmitted by the user interface 702 and is intercepted by the network interceptor 704. The network interceptor 704 uses the identifier 706 for validating the idempotency key. Particularly, in this scenario, the identifier 706 determines that the idempotency key is in an expired state because the same transaction had previously been authorized and processed. The network interceptor 704 then transmits a message to the user interface 702 that the same transaction/payload had previously been authorized, and the request is stopped before it is sent to the payment service 708.

FIG. 7 also shows a third step 3 scenario in which a duplicate payment request, having a different payload (i.e., payment amount) and the same idempotency key, is made. In this scenario, a duplicate call to add a payment is transmitted by the user interface 702 and is intercepted by the network interceptor 704. The network interceptor 704 uses the identifier 706 for validating the idempotency key. Particularly, in this scenario, the identifier 706 determines that the idempotency key is in an expired state because a transaction with the same idempotency key had previously been authorized and processed, but that the payload is different from that previous transaction. The network interceptor 704 then transmits a message to the user interface 702 with an error code indicating that an error had occurred, and the request is stopped before it is sent to the payment service 708.

Accordingly, with this technology, an optimized process for associating payment service requests with an idempotency key and analyzing the idempotency key at defined intervals in order to prevent duplicate transactions is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method of implementing idempotency during web-based transactions, the method being implemented by at least one processor, the method comprising:
intercepting, by the at least one processor via an interceptor, a first request for selecting a payment option, prior to the first request being transmitted to a payment service provider,
wherein the interceptor intercepts a service call associated with the first request;
retrieving, by the at least one processor, an idempotency key that includes at least one from among a session identifier and a device identifier associated with the first request;
transmitting, by the at least one processor via the interceptor, the first request with the retrieved idempotency key from the interceptor to a payment service provider;
intercepting, by the at least one processor via the interceptor, a second request for adding a payment, prior to the second request being transmitted to the payment service provider, wherein the second request includes the idempotency key and a first payment amount;
determining, by the at least one processor, whether the idempotency key is in a valid state by analyzing a lifecycle and status state of the idempotency key;
when the idempotency key is determined to be in the valid state, transmitting, by the at least one processor via the interceptor, the second request from the interceptor to the payment service provider;
receiving, by the at least one processor, a third request from the payment service provider to validate the idempotency key;
determining, by the at least one processor, whether the idempotency key is in the valid state; and
when the idempotency key is determined to be in the valid state, transmitting, by the at least one processor, an authorization for adding the payment to the payment service provider.

2. The method of claim 1, further comprising:
updating, by the at least one processor, a status of the idempotency key based on a result of the transmitting of the authorization.

3. The method of claim 1, further comprising:
intercepting, by the at least one processor, a fourth request to proceed with a payment option, wherein the fourth request includes the idempotency key;
determining, by the at least one processor, whether the idempotency key is in the valid state; and
when the idempotency key is determined to be in the valid state, transmitting, by the at least one processor, the fourth request to the payment service provider.

4. The method of claim 1, further comprising:
when the authorization for adding the payment is transmitted to the payment service provider, updating, by the at least one processor, a status of the idempotency key to an expired state;
intercepting, by the at least one processor, a fifth request to add a payment, wherein the fifth request includes the idempotency key and the first payment amount;
determining, by the at least one processor, that the idempotency key is in the expired state; and
stopping, by the at least one processor, the fifth request from being transmitted to the payment service provider.

5. The method of claim 1, further comprising:
when the authorization for adding the payment is transmitted to the payment service provider, updating, by the at least one processor, a status of the idempotency key to an expired state;
intercepting, by the at least one processor, a sixth request to add a payment, wherein the sixth request includes the idempotency key and a second payment amount that is different from the first payment amount;
determining, by the at least one processor, that the idempotency key is in the expired state;
generating, by the at least one processor, an error code; and
stopping, by the at least one processor, the sixth request from being transmitted to the payment service provider.

6. The method of claim 1, further comprising:
generating, by the at least one processor, the idempotency key prior to the retrieving, based on at least one from among the session identifier and the device identifier.

7. The method of claim 1, further comprising:
determining, by the at least one processor, a status state of the idempotency key; and
storing, by the at least one processor, the status state in a database,
wherein the determining of whether the idempotency key is in the valid state includes retrieving the status state from the database.

8. The method of claim 1, wherein the determining of whether the idempotency key is in the valid state includes ensuring that an order to the payment service provider for adding a payment has not been processed more than once.

9. A computing apparatus for implementing idempotency during web-based transactions, the computing apparatus comprising:
a processor;
a memory; and
a communication interface coupled to each of the processor and the memory,
wherein the processor is configured to:
intercept, via an interceptor, a first request for selecting a payment option, prior to the first request being transmitted to a payment service provider,
wherein the interceptor intercepts a service call associated with the first request;
retrieve an idempotency key that includes at least one from among a session identifier and a device identifier associated with the first request;
transmit, via the interceptor, the first request with the retrieved idempotency key from the interceptor to a payment service provider;
intercept, via the interceptor, a second request for adding a payment, prior to the second request being transmitted to the payment service provider, wherein the second request includes the idempotency key and a first payment amount;
determine whether the idempotency key is in a valid state by analyzing a lifecycle and status state of the idempotency key;
when the idempotency key is determined to be in the valid state, transmit, via the interceptor, the second request from the interceptor to the payment service provider;
receive a third request from the payment service provider to validate the idempotency key;
determine whether the idempotency key is in the valid state; and
when the idempotency key is determined to be in the valid state, transmit an authorization for adding the payment to the payment service provider.

10. The computing apparatus of claim 9, wherein the processor is further configured to update a status of the idempotency key based on a result of the transmitting of the authorization.

11. The computing apparatus of claim 9, wherein the processor is further configured to:
intercept a fourth request to proceed with a payment option, wherein the fourth request includes the idempotency key;
determine whether the idempotency key is in the valid state; and
when the idempotency key is determined to be in the valid state, transmit the fourth request to the payment service provider.

12. The computing apparatus of claim 9, wherein the processor is further configured to:
when the authorization for adding the payment is transmitted to the payment service provider, update a status of the idempotency key to an expired state;
intercept a fifth request to add a payment, wherein the fifth request includes the idempotency key and the first payment amount;
determine that the idempotency key is in the expired state; and
stop the fifth request from being transmitted to the payment service provider.

13. The computing apparatus of claim 9, wherein the processor is further configured to:
when the authorization for adding the payment is transmitted to the payment service provider, update a status of the idempotency key to an expired state;
intercept a sixth request to add a payment, wherein the sixth request includes the idempotency key and a second payment amount that is different from the first payment amount;
determine that the idempotency key is in the expired state;
generate an error code; and
stop the sixth request from being transmitted to the payment service provider.

14. The computing apparatus of claim 9, wherein the processor is further configured to:
generate, based on at least one from among the session identifier and the device identifier, the idempotency key prior to the retrieving.

15. The computing apparatus of claim 9, wherein the processor is further configured to:
determine a status state of the idempotency key; and
store the status state in a database,
wherein the determining of whether the idempotency key is in the valid state includes retrieving the status state from the database.

16. The computing apparatus of claim 9, wherein the determining of whether the idempotency key is in the valid state includes ensuring that an order to the payment service provider for adding a payment has not been processed more than once.

17. A non-transitory computer readable storage medium storing instructions for implementing idempotency during web-based transactions, the storage medium comprising executable code which, when executed by a processor, causes the processor to:
intercept, via an interceptor, a first request for selecting a payment option, prior to the first request being transmitted to a payment service provider,
wherein the interceptor intercepts a service call associated with the first request;
retrieve an idempotency key that includes at least one from among a session identifier and a device identifier associated with the first request;
transmit, via the interceptor, the first request with the retrieved idempotency key from the interceptor to a payment service provider;
intercept, via the interceptor, a second request for adding a payment, prior to the second request being transmitted to the payment service provider, wherein the second request includes the idempotency key and a first payment amount;
determine whether the idempotency key is in a valid state by analyzing a lifecycle and status state of the idempotency key;
when the idempotency key is determined to be in the valid state, transmit, via the interceptor, the second request from the interceptor to the payment service provider;
receive a third request from the payment service provider to validate the idempotency key
determine whether the idempotency key is in the valid state; and
when the idempotency key is determined to be in the valid state, transmit an authorization for adding the payment to the payment service provider.

18. The storage medium of claim 17, wherein, when executed by the processor, the executable code further causes the processor to update a status of the idempotency key based on a result of the transmitting of the authorization.

19. The storage medium of claim 17, wherein, when executed by the processor, the executable code further causes the processor to:
intercept a fourth request to proceed with a payment option, wherein the fourth request includes the idempotency key;
determine whether the idempotency key is in the valid state; and
when the idempotency key is determined to be in the valid state, transmit the fourth request to the payment service provider.

20. The storage medium of claim 17, wherein, when executed by the processor, the executable code further causes the processor to:
when the authorization for adding the payment is transmitted to the payment service provider, update a status of the idempotency key to an expired state;
intercept a fifth request to add a payment, wherein the fifth request includes the idempotency key and the first payment amount;
determine that the idempotency key is in the expired state; and
stop the fifth request from being transmitted to the payment service provider.
